(19) United States
(12) Patent Application Publication
(10) Pub. No.: US 2008/0155408 A1
(43) Pub. Date: Jun. 26, 2008

(54) Systems, Methods and Computer Programs to Generate Reminders at Expiration of a Calendar Event

(75) Inventors: Albert F. Elcock, Havertown, PA (US); Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/613,772

(22) Filed: Dec. 20, 2006

(51) Int. Cl. G06F 3/00

(52) U.S. Cl. 715/703

(57) ABSTRACT

A system, method and computer readable medium are described that issue ending reminders to users. As a user goes through his day, he will be reminded of the beginning of the events he has entered into his calendar. The described systems, methods and programs stored on computer readable medium also allow reminders to be issued at or near the end of certain events. This can typically be used by parents to remind them to pick up their children after their children finish an event such as athletic practice.

### BACKGROUND OF THE INVENTION

Many scheduling software programs are available to users today. These programs allow a user to block off time and set reminders to attend events. An event is an obligation a person accepts to be somewhere or do something at a particular time. Examples of events include business meetings, doctor's appointments and athletic practices. A user typically enters a starting and ending time of an event and the program sends a reminder to or through the user's computer or PDA just before the beginning of the meeting. Microsoft™ Outlook™ is an example of an email-based application that includes a calendar feature. This calendar feature allows a user to block-off time for an event on a particular day and receive a beginning reminder for that event via email.

These events are set as open-ended. That is, the user is reminded just before the beginning of the event so that he or she does not miss it. However, the user is never reminded when the event is over. If the user wants to be reminded, he or she must set a second event, with a beginning time near the ending time of the first event, in the calendar. Thus, the user must enter two events to be reminded of a single event at both the beginning and the end.

One example of where an end reminder is useful involves picking up children after events such as soccer practice. The parent may program “Daughter's Soccer Practice” from 3:00 to 5:00 pm. Thus, if the parent is running errands at 2:30, he or she is reminded of Daughter's soccer practice so he or she can go home to pick-up Daughter and get her to practice on time.

If the parent then returns to running errands, he or she may forget that Daughter's practice ends at 5:00 pm. Traditional software programs do not generate reminders for the end of the events so the parent is never reminded to pick-up Daughter after soccer practice is over.

### BRIEF DESCRIPTION OF THE DRAWINGS

FIG. 1 is a system for generating and managing data representative of events and reminders;

FIG. 2 is a computer-based calendar that displays data representative of several events and reminders;

FIG. 3 is an illustrative graphical user interface for setting data that represents events, beginning reminders and ending reminders; and

FIG. 4 is a flowchart for a process for using data representative of events, beginning reminders and ending reminders.

### DETAILED DESCRIPTION

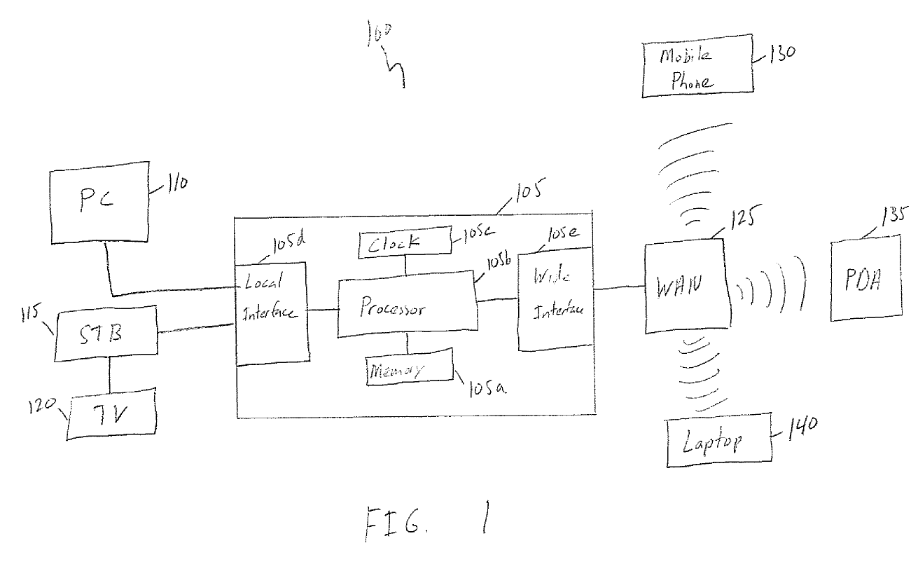

FIG. 1 shows a system 100 for generating and managing data representative of events and reminders. System 100 includes a residential gateway, central hub or server 105. In one illustrative system, server 105 is a residential gateway. Server 105 is coupled to a personal computer (PC) 110, a set-top box (STB) 115 and one or more wide area networks (WAN) 125 (only one is shown for the sake of simplicity). STB 115 is also coupled to television 120. In some implementations, server 105 includes the functionality of the STB 115 such that server 105 can be coupled directly to television 120.

The connections between server 105 and PC 110, STB 115 and WAN 125 are shown as wired connections and can include Ethernet cables, coaxial cables, twisted-pair wires, fiber optic cables, power supply lines etc. These wired connections may implement any of a plurality of protocols such as TCP/IP, MoCA or Homeplug™ to transfer data there between. In alternative illustrative systems, some or all of these connections may be wireless and supported by protocols such as Bluetooth™, 802.11x, Zigbee™, WiMAX or 802.16x.

WAN 125 may include cable company components such as a headend or CMTS. WAN 125 is also coupled to a mobile phone 130, a personal digital assistant (PDA) 135 or laptop 140. The connections between WAN 125 and mobile phone 130, PDA 135 and laptop 140 are shown as wireless connections. These wireless connections may be any type of terrestrial or satellite transmission system and may implement any of a plurality of protocols such as CDMA, GSM, Wi-MAX, WiFi, 802.16, 802.11 etc. In alternative systems, these wireless connections may be replaced, on a permanent or temporary basis, by a wired connection (e.g., connecting laptop 140 to server 105 via an Ethernet cable). In general, any device shown in FIG. 1 is capable of sending and receiving data to and from any other device shown in FIG. 1.

Server 105 is itself comprised of several sub-systems. Server 105 contains a memory 105a. Typically this memory is a semiconductor memory (such as RAM or ROM) or a magnetic memory such as a hard disk drive. Coupled to memory 105a is a processor 105b. Processor 105b performs arithmetic and logical operations as well as controlling movement of data into, through and out of server 105. Processor 105b is also coupled to a clock circuit 105c. Clock circuit 105c provides clock signals for comparison as to when reminders need to be issued. Finally, server 105 includes a local interface 105d and a wide interface 105e. Local interface 105d couples server 105 to local devices such as PC 110 and STB 115 through a local network. As previously explained, local interface 105d may support wired, wireless or a combination of both types of connections. Wide interface 105e is coupled to one or more wide area networks 125. Wide interface 105e may support wired, wireless or a combination of both types of connections.

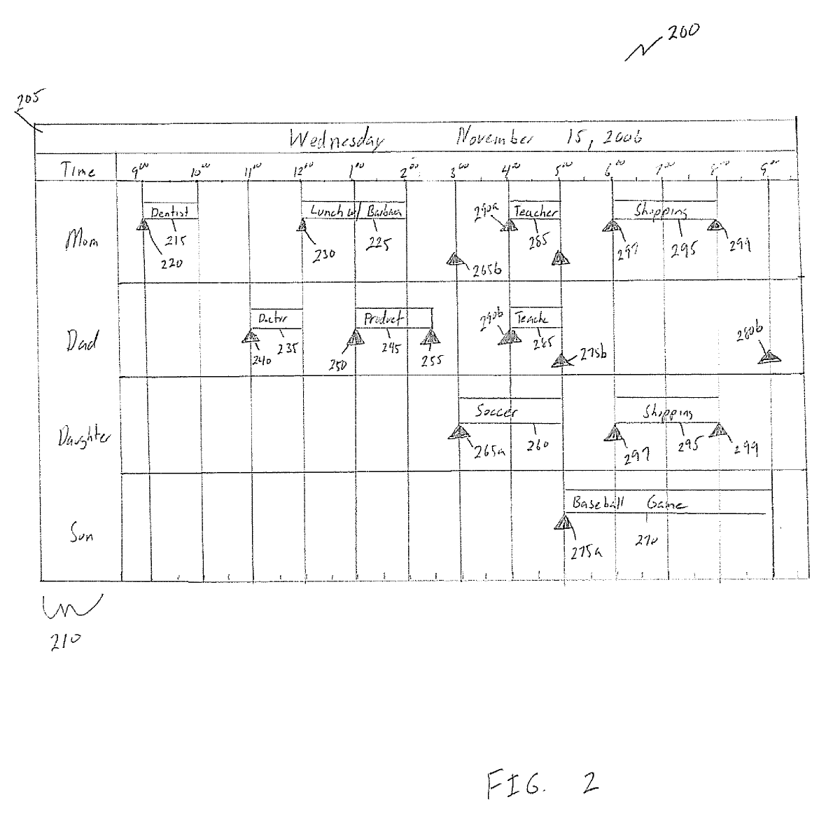

FIG. 2 shows a screen-shot 200 of a user interface illustrating several events on a group calendar day 200. Each event is represented in a database. These representations are shown in FIG. 2 and assist each user in managing his or her time effectively and for being reminded of when events begin or end. The date of this particular instance is shown in box 205. The list of users is listed in box 210. In this example, every user has at least one event that he or she wants to attend or be reminded about. For example, Mom has a dentist appointment event 215 at 9:00 AM. She has a beginning reminder 220 set to remind her before the appointment so she doesn't forget. Later in the day, she is scheduled to have a lunch event 225 starting at 12:00 PM that has a beginning reminder 230 associated with it. Mom also has a beginning reminder 265b and an ending reminder 270b for another event.

Dad has a doctor's appointment event 235 scheduled for 11:00 AM with a beginning reminder 240 set. Later in the day, Dad has a Product Meeting event 245. Product Meeting event 245 has both a beginning reminder 250 set at 1:00 pm and an ending reminder 255 set for 2:30 pm. Dad also has a beginning reminder 275b and an ending reminder 280b for another event.

Daughter has a soccer practice event 260 scheduled between 3:00 PM and 5:00 PM. Her soccer practice event 260 has a beginning reminder 250a associated with it. Similarly, Son has a baseball game event 270 scheduled between 5:00 PM and 9:00 PM with a beginning reminder 275a.

A first shared event 285, a teacher's conference, is scheduled for both Mom and Dad. A shared event is one where one or more people are planning on attending. Another shared event 295, a shopping trip, is schedule for both Mom and Daughter from 6:00 to 8:00. The teacher's conference event 285 has beginning reminders 290a and 290b associated with it. The Shopping Trip event 295 has both beginning reminders 297 and ending reminders 299 set for both Mom and Daughter.

All of the events 215, 225, 235, 245, 260, 270, 285 and 295 can be categorized into one of two groups. Those events that only have beginning reminders like events 215, 225, 235, 260, 270 and 285 and those events that have both beginning and ending reminders like events 245, 260, 270 and 295. This is because determining the end times of certain events is difficult and impractical. For instance, Mom can arrive at the dentist's office early for her 9:00 AM appointment, but there is no guarantee that the dentist won't have an emergency patient he takes in front of her or is otherwise running late from his 8:30 AM appointment. Thus, it is meaningless for her to enter an ending reminder since she will not leave the dentist's office until he is done examining her teeth. This goes for Dad's doctor's appointment 235 and the shared teacher's conference event 275 as well.

It should be noted that some events could also end early. Dad's doctor's appointment event 235 is “scheduled” to end at 12:00 in FIG. 2. This, however, is merely a best guess as to when it could end. If the doctor is on time, and Dad's visit is relatively simple, he could leave well before 12:00. Thus, while Dad's doctor's appointment event 235 does show an end time, it isn't efficient for him to receive an ending reminder. Dad will know when it is time to leave based on when the doctor tells him to leave.

The other events, on the other hand, have very predictable ending times. For example, Daughters' soccer practice always ends at 5:00 PM. With this knowledge it is reasonable to set ending reminder 270b for Mom accordingly. However, an ending reminder is not needed in Daughter's portion of the calendar. In this case, Daughter doesn't need a reminder as she will be at soccer practice. She will know when practice is over. The same for Son's baseball game. Reminders are necessary for Mom and Dad in order to pick Daughter or Son up after their respective events are over. Thus, ending reminders 270b and 280b are set in Mom's and Dad's calendars, respectively.

Like shared events, there are also shared reminders. For instance, Mom and Daughter share beginning reminders 265a and 265b for Daughter's soccer practice event 260 and beginning reminders 297 and ending reminders 299 for the Shopping Trip event 295. Similarly, Dad and Son share beginning reminders 275a and 270b. A shared reminder may be different from a shared event in that not everyone may participate in the event necessitating the reminder. In contrast, both Mom and Dad are expecting to attend the teacher's conference event 275. Likewise, both Mom and Daughter are expecting to attend the Shopping Trip event.

A shared reminder is issued to two or more people even though everyone may not attend the event. For instance, Mom needs to be reminded to take and pick-up Daughter to and from soccer practice, but Mom will not attend soccer practice herself. Thus, shared beginning reminders 265a and 265b remind both Mom and Daughter of the upcoming soccer practice event.

Some events do have both beginning and ending reminders. For instance, Dad's Product Meeting 245 has both a beginning reminder 250 and an ending reminder 255. One purpose of beginning reminder 250 is to inform Dad of the upcoming meeting. One purpose for ending reminder 255 is to inform Dad that he is near the end of his meeting. This can be particular useful if Dad has a tendency to let his meetings run long. He can use ending reminder 255 to hurry-up and finish his meeting on time.

Shopping Trip event 295 also has beginning reminders 297 and ending reminders 299. The ending reminders 299 are used so that Mom and Daughter can separate while at the mall and do their own shopping. The ending reminders 299 are issued to inform Mom and Daughter to finish-up their shopping and rendezvous at the designated place on time.

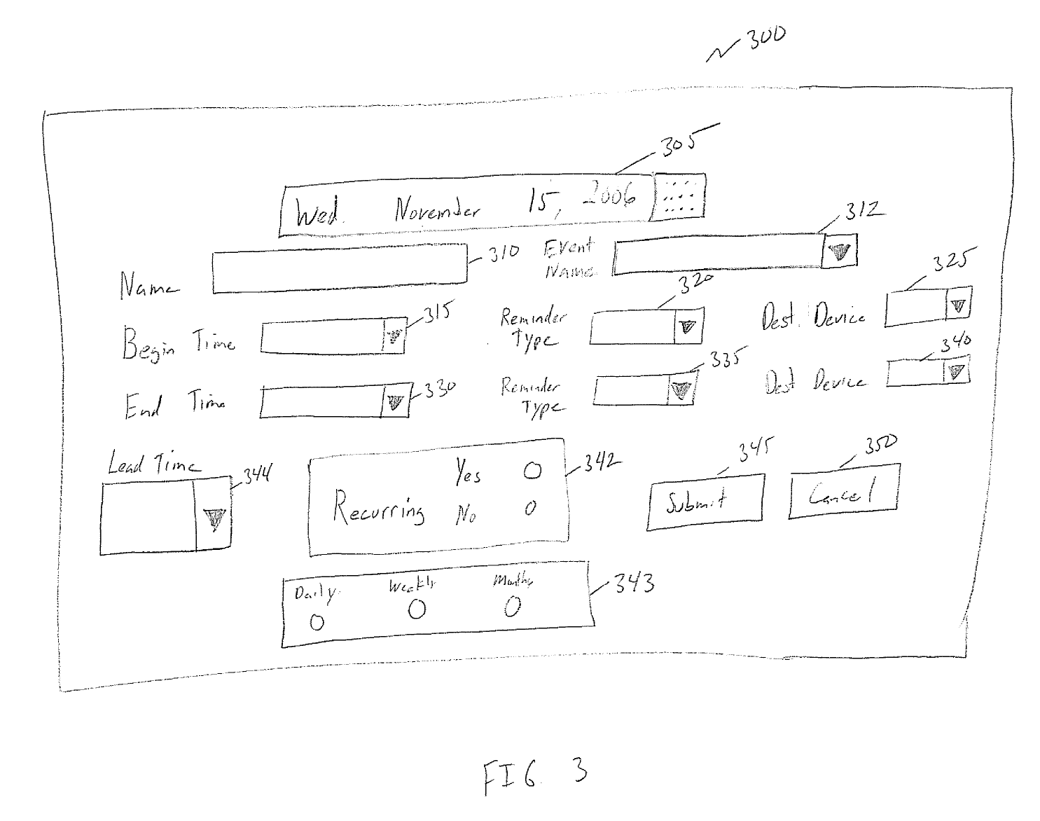

FIG. 3 shows an illustrative screen 300 from a user interface for entering event and reminder data into a data base. Screen 300 includes the day 305 on which the event is to occur. The user then enters a name or names associated with that event in box 310. These are typically any of the names listed in box 210 in FIG. 2. For some events, like Mom's 9:00 am dentist appointment event 215, only one name is entered in box 310. For shared events, like the teacher's conference event 275, multiple names are entered into box 310. The user then enters an event name such as “Soccer Practice” in box 312. The user then enters a beginning time for the event into box 315. The user may do this by typing the time directly or by using a drop-down menu that includes many different times in various increments. In box 320 the user enters a type of reminder. Since there are a plurality of destination devices that can be used, the user can select from an audio reminder, a video reminder, a textual reminder or any combination depending on the capabilities of the destination device.

A textual reminder may be something as listing the event followed by a time until it begins. Thus, a textual reminder for Daughter's soccer practice could be “Daughter's Soccer Practice at 3:00” or “Daughter's Soccer Practice in 10 minutes.” Thus, options the user could select from include Standard Text at Start Time (e.g., “Daughter's Soccer Practice at 3:00”) or Standard Text with Time to Go (e.g., “Daughter's Soccer Practice in 15 minutes”).

For a simple audio or video message, a tone series or series of frames could be issued at the appropriate time. For a custom audio or video message, the user could record and store it in memory 105a. This message could then be issued at the appropriate time.

Like reminder box 320, destination device box 325 could also allow input of multiple devices. For example, Dad may want beginning reminder 240 sent to both his work email address (i.e., his computer at work) and his PDA. That way, he can be reminded if he is sitting at his desk via his work email or if he is in someone else's office having an impromptu meeting via his PDA.

This feature also works with shared reminders. For example, reminder 265a can be set by selecting “Daughter's Mobile Phone” and reminder 265b can be set by selecting “Mom's Mobile Phone.” Thus, if only a single reminder type is picked in box 320, say an audio message that plays “Daughter's soccer practice at 3:00,” both cell phones will receive and play the same message at substantially the same time.

If two reminder types are selected in box 320, box 325 will offer the user two options for destination devices. As an example, if the user selects both a text reminder type and a simple audio reminder, the user can then select two devices. For the text message, the user may select a particular user's PDA. For the audio reminder, the user may select a laptop associated with either the same or different user.

The user selects a destination device at box 325. Again, the user could either type it in directly or choose from a stored entry by using the drop-down button. Examples of destination devices include Mom's Mobile Phone, Dad's Work Email, Home Phone, etc.

In box 342, the user may select whether this event is recurring or not. A recurring event is one that occurs periodically. These are typically daily, weekly or monthly meetings that occur at the same time of day (e.g., soccer practice every weekday from 3:00 to 5:00). The user then selects the period of recurrence in box 343.

In box 344 the user selects how much lead time to issue the reminder before either the beginning or ending of the event. For example, for the user could enter 15 minutes in box 344. Thus, beginning reminders 265a and 265b would be issued at 2:45 for Daughter's 3:00 Soccer Practice. Similarly, ending reminder 270 would be issued at 4:45. It should be noted that alternative systems and methods allow for setting separate lead times for both beginning and ending reminders. That is, beginning reminder 265a could be issued 20 minutes early at 2:40 while ending reminder 270b is issued at 4:50.

The user then selects the ending time (if necessary) at box 330, the type of reminder for the ending time in box 335 and the destination device in box 340. This is similar for making selections in boxes 315, 320 and 325.

Once all of the data has been entered, the user hits the submit button 345. Alternatively, if the user does not want to set reminders for this event, he or she would hit the cancel button 350.

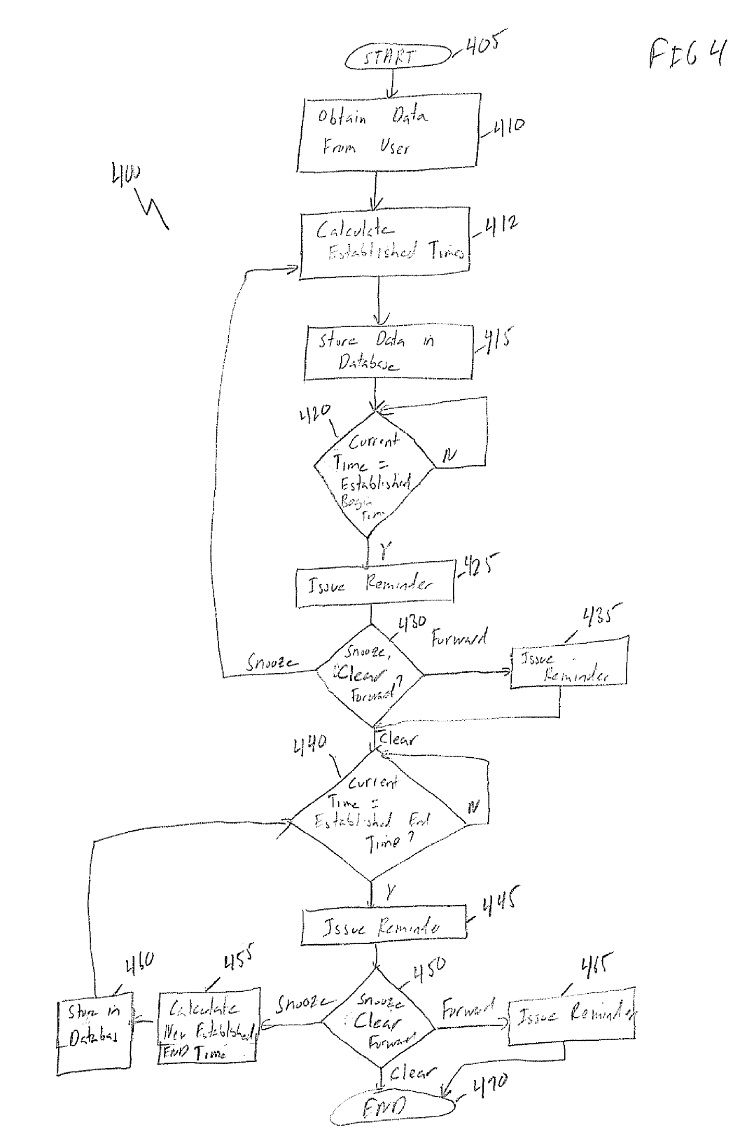

FIG. 4 shows an illustrative process 400 for setting beginning and ending reminders for an event. The process begins at step 405. At step 410, the system obtains user data. This data pertains to the beginning and ending times of the event, which person is scheduled to go to the event and what devices are to receive the reminders. This data is typically obtained using a graphical user interface such as the one shown in FIG. 3 and stored in memory 105a in server 105.

After the system has obtained the information, processor 105b uses the entered lead time to generate established times at step 412. That is, the received lead time data is subtracted from the received beginning and ending times data. In general, it is more helpful to generate established times so as to be reminded of an event before the actual beginning of the event. For example, if soccer practice begins at 3:00, it is better to be reminded at 2:30 or 2:45 of the upcoming soccer practice so they can leave on time and arrive at the field at 3:00.

If the beginning time entered box 315 is 3:00 pm, processor 105b will subtract the lead time set by the user, e.g., 15 minutes, from 3:00 to generate an established time of 2:45. A similar process occurs for the ending time. This allows a parent to leave home before soccer practice is over and arrive in time to pick up his or her child. Both the entered data and the established data are stored in a central database at step 415 (e.g., memory 105a).

After all of the data has been received and calculated, processor 105b checks the current date and time at step 420 and compares it to a calculated, established beginning time before a beginning of an event. If there is no match, the system checks the time again. It should be noted that this time checking can be done periodically (say every minute or every 15 minutes) instead of every fraction of a second.

If processor 105a determines that the current date and time match an established time before the beginning of the event, the processor issues a reminder notice to the particular destination devices at step 425. That is, processor 105b retrieves the reminder(s) and the destination device(s) stored in memory 105a. If processor 105a knows which network the destination device is on, it will retrieve an address (if necessary) for the destination device, format the reminder for transmission and forward it to the appropriate interface 105d or 105e. As an example, set-top box 115 will be assumed to be connected to local interface 105d. Thus, if processor 105b determines this reminder is for set-top box 115, it will forward the reminder to set-top box 115 via local interface 105d. If the reminder is for mobile phone 130, processor 105b will forward the reminder over wide interface 105e to mobile phone 130. In some cases, the destination device could be on either network. For example, mobile phone 130 could be coupled to server 105 via a docking station (not shown) and local interface 105d instead of through wide interface 105e. Processor 105b may poll both interfaces 105d and 105e to locate the destination device in order to send the reminder out over the correct interface.

Also in step 425, the reminder is rendered. If the reminder is an audio reminder, it is played through a speaker so the user can hear it. If the reminder contains video or images, it is displayed on a screen.

At step 430, the user decides on how to use this reminder. For example, one thing the user could do is snooze this reminder. That is, the user has been warned of the upcoming event in plenty of time, but needs just a couple of more minutes to finish what she is currently doing. Thus, the user wants to be reminded again in some amount of time, say five minutes. If the user chooses to snooze this reminder, a message is sent from the destination device to server 105 indicating the user's desire to snooze this reminder. The process the goes to step 412 where a new beginning established time is calculated and the process continues as previously described. As an example, if the user wants to snooze the reminder for 5 minutes and the reminder was sent at 2:45, the new beginning established time of 2:50 will calculated at step 412.

If the user cannot process the reminder the user may forward it to someone else via a different destination device. As an example, suppose Mom cannot take Daughter to soccer practice at 3:00, but she still receives beginning reminder 265b. As can be seen in FIG. 3, Dad did not receive the initial beginning reminder. Mom could forward beginning reminder 265b to Dad's PDA or work computer via email. That is, Mom pushes an appropriate button or buttons, or uses a graphical user interface, on her destination device, which in turn causes her destination device to send a message to server 105 indicating her desire to forward the reminder to someone else or to some other destination device. In many implementations, Mom will be given the option to append a short message such as “Stuck in traffic. Can you take Daughter to soccer practice?” before forwarding the message to Dad. Once server 105 receives the forward message from the first destination device, it retrieves the reminder from memory 105a and determines the new destination device from the message received from the first destination device. Server 105 then issues the reminder to the new destination device selected by the user at step 435.

Finally, the user could clear the reminder at step 430. If the user can attend the event or execute an action (e.g., take Daughter to soccer practice) based on the reminder, she will clear it at step 430.

After the user clears or forwards the beginning reminder, server 105 then checks the current date and time against an established ending time for the event at step 440. If the times don't match, server 105 checks and compares the times again later as described in conjunction with step 420. If the current date and time match the established ending time at step 430, an ending reminder is issued at step 445. The process then continues with steps 450-465. Steps 450-465 are similar to steps 430, 435, 412 and 415, respectively.

The process shown in FIG. 4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

While the above systems and methods have been described with specific references to specific figures, one of ordinary skill in the art would recognize several variations. For example, FIG. 4 describes a periodic time checking by the processor 105b. An alternative system and method could use interrupts. These interrupts cause processor 105b to compare the current time with the times entered for both beginning and ending reminders only upon receipt of those interrupts.

The system 100 was also described as hosting the data and process for generating and issuing reminders. In this case, server 105 issues a reminder when it transmits the reminder at the correct time. As an example, server 105 transmits a voice message saying “Daughter's Soccer Practice at 3:00,” to a particular destination device.

Other implementations can be hosted in a destination device such as mobile phone 130, PDA 135 and laptop 140. That is the process shown in FIG. 4 can be implemented using a processor, memory and clock circuit resident in the destination device. In such an implementation, the portable device may synchronize with server 105 periodically so that the user of the portable device can receive event and reminder data entered by another user.

One way to synchronize a portable device is to have a docking station as part of server 105. The user could place the portable device in the docking station at the end of the day to charge the battery. While the battery is charging, server 105 would upload and download event and reminder information between devices. For example, Mom could use an interface like the one shown in FIG. 3 on her mobile phone to establish data representative of an event and reminders. One reminder may be a shared reminder like 265a and 265b or 290a and 290b. Thus, the data for reminder 290b, such as the time and content of the reminder, must be downloaded from Mom's mobile phone into server 105. Later, when Dad's PDA is connected to server 105, server 105 will upload data for reminder 290b into his PDA. Thus, data representative of reminder 290a will be stored in Mom's cell phone and data representative of reminder 290b will be stored in Dad's PDA.

After the synchronization, each destination device will follow the process in FIG. 4. As an example, both Mom's and Daughter's mobile phones will independently determine when to issue and render their respective reminders. If Mom cannot execute on that reminder, she can forward it to another destination device. In this case, the forward message includes the content of the reminder along with the name or address of the destination device. This message is sent to server 105 where it is rerouted to the new destination device where it is rendered. In some cases, server 105 is not needed to forward the message that includes the reminder data between destination devices. As an example, if the message is between two mobile phones on the same network, they can transmit and receive this message on that network alone without going through server 105.

1. A method for issuing at least one reminder associated with an event comprising:
determining a first current time;
comparing the first current time to an established ending time; and
issuing a first reminder if the first current time matches the established ending time.

2. The method of claim 1 further comprising:
determining a second current time;
comparing the second current time to an established beginning time event; and
issuing a second reminder if the second current time matches the established beginning time.

3. The method of claim 1 further comprising:
issuing a third reminder if the first current time matches the established ending time.

4. The method of claim 1 wherein the issuing the first reminder further comprises:
transmitting the first reminder from a first device to a second device.

5. The method of claim 3 wherein the issuing the third reminder further comprises:
transmitting the third reminder from a first device to a third device.

6. The method of claim 1 further comprising:
receiving a snooze command;
calculating a new established ending time determining a third current time;
comparing the third current time to the new established ending date and time; and
issuing a second reminder if the third current time matches the new established ending time.

7. A computer readable medium comprising a computer program wherein the computer program comprises instructions for controlling the operation of a processor so the processor's operations comprise:
determining a first current time;
comparing the first current time to an established ending time; and
issuing a first reminder if the first current time matches the established ending time.

8. The computer readable medium of claim 7 further comprising instructions for:
determining a second current time;
comparing the second current time to an established beginning time event; and
issuing a second reminder if the second current time matches the established beginning time.

9. The computer readable medium of claim 7 further comprising instructions for:
issuing a third reminder if the first current time matches the established ending time.

10. The computer readable medium of claim 7 further comprising instructions for:
transmitting the first reminder from a first device to a second device.

11. The computer readable medium of claim 9 further comprising instructions for:
transmitting the third reminder from a first device to a third device.

12. The computer readable medium of claim 7 further comprising instructions for:
receiving a snooze command;
calculating a new established ending time determining a third current time;
comparing the third current time to the new established ending date and time; and
issuing a second reminder if the third current time matches the new established ending time.

13. A system for issuing an ending reminder comprised of:
a processor that calculates an established ending time;
a memory that stores the established ending time;
a clock that generates a current time; wherein
the processor compares the current time with the established ending time and issues a reminder if the current time matches the established ending time.

14. The system of claim 13 further comprising:
a local interface that receives the reminder from the processor and forwards it over a local network.

15. The system of claim 14 further comprising:
a television coupled to the local interface.

16. The system of claim 13 further comprising:
a local interface that receives the reminder from the processor and transmits it to a wide area network.

17. The system of claim 16 further comprising:
a mobile radiotelephone coupled to the wide area network that receives the reminder over the wide area network.

18. The system of claim 13 wherein the processor, memory and clock are all integrated into a portable device.

19. The system of claim 18 wherein the portable device is a mobile radiotelephone.

20. The system of claim 19 wherein the portable device is a PDA.
